(19) United States
(12) Patent Application Publication
(10) Pub. No.: US 2006/0247371 A1
(43) Pub. Date: Nov. 2, 2006

(54) Binder mixtures of polyaspartates and sulfonate-modified polyisocyanates

(75) Inventors: Holger Mundstock, Wermelskirchen (DE); Meike Niesten, Koln (DE); Nicole Reidenbach, Leverkusen (DE); Jorg Schmitz, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/410,405

(22) Filed: Apr. 25, 2006

(30) Foreign Application Priority Data
Apr. 30, 2005 (DE) 102005020269.1

(51) Int. Cl. C08G 18/08

(52) U.S. Cl. 524/589

(57) ABSTRACT

The present invention relates to two-component coating systems for the production of polyurea coatings containing A) a sulfonate group-containing polyisocyanate and
B) an amino-functional polyaspartate corresponding to formula (I) 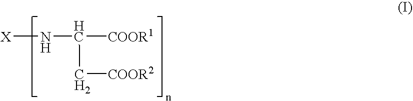 wherein X represents the n-valent organic group obtained by removing the primary amino groups from an n-valent polyamine,
R¹, R² represent the same or different organic groups, which are inert to isocyanate groups under the reaction conditions, and n represents an integer of at least 2. The present invention also relates to coatings obtained from these coating systems.

### BACKGROUND OF THE INVENTION

1. Field of the Invention

The present invention relates to novel two-component polyurea coating systems based on sulfonate-modified polyisocyanates and certain amino-functional hardeners.

2. Description of Related Art

Two-component coating systems based on polyurethanes or polyureas are known and are widely used in industry. They generally contain a liquid polyisocyanate component and a liquid isocyanate-reactive component. The reaction of polyisocyanates with amines results in strongly crosslinked polyurea coatings. However, primary amines and isocyanates usually react together very rapidly. Often, therefore, typical pot lives or gel times of such systems are only between several seconds and a few minutes. Thus, these polyurea coatings cannot be applied manually but only using special spray apparatus. However, these coatings possess excellent physical properties and are therefore of great interest, despite the difficulty in applying them.

Low-viscosity blocked amines, such as ketimines and aldimines, are used to control reactivity (Squiller, Wicks, Yeske, ‘High Solids Polyurethane Coatings’ in Polymeric Materials Encyclopedia, J. C. Salamone, ed., CRC Press, 1996, vol. 5, DE-OS 1 520 139 or DE-OS 3 308 418). Deblocking (hydrolysis) takes place under the action of atmospheric humidity, with release of the primary amine.

Another way of inhibiting the reaction between polyisocyanates and amines is the use of sterically hindered secondary amines. EP-A 403 921 and U.S. Pat. No. 5,126,170 disclose the formation of polyurea coatings by the reaction of polyaspartates with polyisocyanates. Polyaspartates possess low viscosity and reduced reactivity towards polyisocyanates compared with other secondary aliphatic amines. Types with different reactivities are available, depending on their molecular structure. Thus, both solvent-free or low-solvent coating systems with prolonged pot lives and drying times, and systems with very rapid drying times and shorter pot lives, can be produced.

In practice, the aldimines and ketimines previously mentioned are often combined with polyaspartates.

The disadvantage of these systems when conventional polyisocyanates are used as hardeners is fact that they result in either rapid drying with a short pot life or a long pot life with slow drying.

An object of the present invention is to provide novel polyurea systems that display markedly faster curing than known systems from the prior art, together with the same or a prolonged pot life.

Surprisingly, it has now been found that this object can be achieved by using sulfonate-modified polyisocyanates as reactants for the amino-functional binders based on polyaspartates or a mixture thereof with aldimines or ketimines. A particular advantage of the systems according to the invention is that they can be processed and applied using commercial techniques known for two-component polyurethane coating systems. Special equipment is therefore not necessary.

### SUMMARY OF THE INVENTION

The present invention relates to two-component coating systems for the production of polyurea coatings containing

A) a sulfonate group-containing polyisocyanate and

B) an amino-functional polyaspartate corresponding to formula (I)

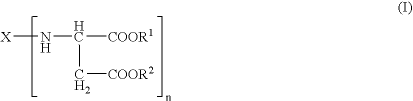

wherein
x represents the n-valent organic group obtained by removing the primary amino groups from an n-valent polyamine,
R¹, R² represent the same or different organic groups, which are inert to isocyanate groups under the reaction conditions, and
n represents an integer of at least 2.
   The present invention also relates to coatings obtained from these coating systems.

### DETAILED DESCRIPTION OF THE INVENTION

The polyisocyanates employed in A) have one or more sulfonic acid or sulfonate groups in addition to free NCO groups. The production of these modified polyisocyanates is described in detail in WO-A 01-88006 (U.S. Pat. No. 6,767,958, herein incorporated by reference).

Polyisocyanates A) are prepared from organic polyisocyanates, preferably with an average NCO functionality of at least 2 and a molecular weight of at least 140 g/mol. Particularly suitable are (i) unmodified organic polyisocyanates in the molecular weight range of 140 to 300 g/mol, (ii) lacquer polyisocyanates with a molecular weight of 300 to 1000 g/mol and (iii) urethane group-containing NCO prepolymers with a molecular weight, Mn, of more than 1000 g/mol, or mixtures of (i) to (iii).

Examples of polyisocyanates i) include 1,4-diisocyanatobutane, 1,6-diisocyanato-hexane (HDI), 1,5-diisocyanato-2,2-dimethylpentane, 2,2,4- or 2,4,4-trimethyl-1,6-diisocyanatohexane, 1-isocyanato-3,3,5-trimethyl-5-isocyanatomethyl-cyclohexane (IPDI), 1-isocyanato-1-methyl-4-(3)-isocyanatomethylcyclohexane, bis(4-isocyanatocyclohexyl)methane, 1,10-diisocyanatodecane, 1,12-diisocyanato-dodecane, 1,3- and 1,4-cyclohexane diisocyanate, xylylene diisocyanate isomers, triisocyanatononane (TIN), 2,4-diisocyanatotoluene or mixtures thereof with 2,6-diisocyanatotoluene (preferably mixtures with up to 35 wt. % of 2,6-diisocyanato-toluene), 2,2′-2,4′-, 4,4′-diisocyanatodiphenylmethane, polyisocyanate mixtures from the diphenylmethane series or any mixtures of the above isocyanates. Polyisocyanates ii) include the known lacquer polyisocyanates. In the context of the invention, the term “lacquer polyisocyanates” means compounds or mixtures of compounds that are obtained by the known oligomerization reaction of monomeric diisocyanates such as those set forth in i). Suitable oligomerization reactions include carbodiimidization, dimerization, trimerization, biuretization, urea formation, urethanization, allophanatization and/or cyclization to form oxadiazine groups. During “oligomerization”, several of the above reactions often take place simultaneously or consecutively.

The “lacquer polyisocyanates” (ii) are preferably biuret polyisocyanates, isocyanurate group-containing polyisocyanates, isocyanurate and uretdione group-containing polyisocyanate mixtures, urethane and/or allophanate group- and/or oxadiazine group-containing polyisocyanates, or isocyanurate and allophanate and oxadiazine group-containing polyisocyanate mixtures prepared from monomeric diisocyanates.

The production of these lacquer polyisocyanates is known and is described e.g. in DE-A 1 595 273, DE-A 3 700 209 and DE-A 3 900 053 or in EP-A-0 330 966, EP-A 0 259 233, EP-A 0-377 177, EP-A-0 496 208, EP-A-0 524 501 or U.S. Pat. No. 4,385,171.

Polyisocyanates iii) include the known urethane group-containing NCO prepolymers that are prepared from the monomeric diisocyanates mentioned under i), and/or the lacquer polyisocyanates mentioned under ii), and organic polyhydroxy compounds with a number average molecular weight of more than 300 g/mol. The urethane group-containing lacquer polyisocyanates ii) are prepared from low molecular weight polyols in the molecular weight range of 62 to 300 g/mol, such as ethylene glycol, propylene glycol, trimethylolpropane, glycerol or mixtures of these alcohols. To the contrary NCO prepolymers iii) are prepared from polyhydroxy compounds with a number average molecular weight of more than 300 g/mol, preferably more than 500 g/mol, and more preferably 500 to 8000 g/mol. Preferred polyhydroxy compounds are those with 2 to 6, preferably 2 to 3, hydroxyl groups per molecule and include ether, ester, thioether, carbonate and polyacrylate polyols and mixtures of these polyols.

To produce NCO prepolymers iii) or mixtures thereof with lacquer polyisocyanates ii), diisocyanates i) or lacquer polyisocyanates ii) are reacted with the high molecular weight hydroxy compounds or mixtures thereof with low molecular weight polyhydroxy compounds at an NCO/OH equivalent ratio of 1.1:1 to 40:1, preferably 2:1 to 25:1, with the formation of urethane groups. When an excess of distillable starting diisocyanate is used, it can optionally be removed by distillation following the reaction so that monomer-free NCO prepolymers are present.

In the production of NCO prepolymers iii), the high molecular weight polyols can be used in admixture with the low molecular weight polyols, so that mixtures of low molecular weight, urethane group-containing lacquer polyisocyanates ii) and higher molecular weight NCO prepolymers iii) result directly.

To produce sulfonate-modified polyisocyanates A), starting polyisocyanates i), ii) and/or iii) are optionally reacted with bifunctional polyethers, with partial urethanization of the NCO groups, and then reacted with compounds having at least one isocyanate-reactive group, such as an OH or NH group, and at least one sulfonic acid or sulfonate group. These isocyanate-reactive compounds are preferably 2-(cyclohexylamino)ethanesulfonic acid and/or 3-cyclohexyl-amino)propanesulfonic acid. After building the polymer, the sulfonic acid groups are completely or partly neutralized by adding a base, preferably a tertiary amine.

The starting polyisocyanates are preferably based on hexamethylene diisocyanate, isophorone diisocyanate and/or 4,4′-dicyclohexylmethane diisocyanate.

The resulting sulfonate-modified polyisocyanates A) preferably have an average isocyanate functionality of at least 1.8, an isocyanate group content (calculated as NCO, molecular weight 42) of 4.0 to 26.0 wt. % and a bound sulfonic acid and sulfonate group content (calculated as SO₃, molecular weight 80) of 0.1 to 7.7 wt. %.

If polyether units are incorporated, the content of ethylene oxide units (calculated as C₂H₂O, molecular weight 44) bound within polyether chains in the sulfonate-modified polyisocyanate is 0 to 19.5 wt. %. These optionally incorporated polyether chains preferably contain an average of 5 to 35 ethylene oxide units.

The sulfonate groups preferably have an ammonium ion as counterion formed from tertiary amines by protonation. The ratio of the sum of sulfonic acid groups and sulfonate groups to the sum of tertiary amine and the protonated ammonium ion derived therefrom is preferably 0.2 to 2.0.

Examples of tertiary amines include monoamines, such as trimethylamine, triethylamine, tripropylamine, tributylamine, dimethylcyclohexylamine, N-methylmorpholine, N-ethylmorpholine, N-methylpiperidine or N-ethylpiperidine; or tertiary diamines, such as 1,3-bis(dimethylamino)propane, 1,4-bis(dimethylamino)butane or N,N′-dimethylpiperazine. Tertiary amines having isocyanate-reactive groups, such as the alkanolamines, e.g., dimethylethanol-amine, methyldiethanolamine or triethanolamine are also suitable, but less preferred, neutralizing amines. Dimethylcyclohexylamine is preferred.

In addition to sulfonate-modified polyisocyanates A), non-sulfonate-modified polyisocyanates can also be present in the coating compositions according to the invention. These sulfonate group-free polyisocyanates preferably correspond to the starting isocyanates i) to iii) used to prepare the sulfonate group-containing polyisocyanates.

When sulfonate group-free polyisocyanates are also used, the weight ratio of sulfonate group-containing to sulfonate group-free polyisocyanates is 99:1 to 10:90, preferably 80:20 to 20:80.

In formula I) of the polyaspartates of component B), the residue X is preferably obtained from an n-valent polyamine selected from ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-amino-methylcyclohexane, 2,4- and/or 2,6-hexahydrotoluylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane and polyether polyamines with aliphatically bound primary amino groups and having a number average molecular weight Mn of 148 to 6000 g/mol.

The residue X is more preferably obtained from 1,4-diaminobutane, 1,6-diaminohexane, 2,2,4- and/or 2,4,4-trimethyl-1,6-diaminohexane, 1-amino-3,3,5-trimethyl-5-aminomethylcyclohexane, 4,4′-diaminodicyclohexylmethane or 3,3′-dimethyl-4,4′-diaminodicyclohexylmethane.

The phrase “inert to isocyanate groups under the reaction conditions,” which is used to define groups R¹ and R², means that these groups do not have Zerevitinov-active hydrogens (CH-acid compounds; cf. Römpp Chemie Lexikon, Georg Thieme Verlag Stuttgart), such as OH, NH or SH.

R¹ and R², independently of one another, are preferably C₁ to C₁₀ alkyl residues, more preferably methyl or ethyl residues.

When X is the residue obtained from 2,4,4′-triamino-5-methyldicyclohexylmethane, R¹ and R² are preferably ethyl.

In formula I), n is preferably an integer from 2 to 6, more preferably 2 to 4.

The production of amino-functional polyaspartates B) takes place in known manner by reacting the corresponding primary polyamines of the formula
X—└—NH₂┘ₙ
with maleic or fumaric acid esters of the formula
R¹OOC—CR³═CR⁴—COOR²

Suitable polyamines are the above-mentioned diamines. Examples of suitable maleic or fumaric acid esters are dimethyl maleate, diethyl maleate, dibutyl maleate and the corresponding fumarates.

The production of amino-functional polyaspartates B) from the above-mentioned starting materials preferably takes place within the temperature range of 0 to 100° C. The starting materials are used in amounts such that there is at least one, preferably one, olefinic double bond for each primary amino group. Any starting materials used in excess can be separated off by distillation following the reaction. The reaction can take place in the presence or absence of suitable solvents, such as methanol, ethanol, propanol, dioxane or mixtures thereof.

In addition to amino-functional polyaspartates, the coating systems according to the invention may also contain compounds in the molecular weight range Mₙ of 112 to 6500 g/mol that have at least two structural units of formula (II) 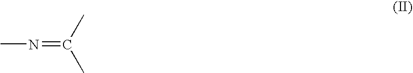
per molecule.

These optional compounds with capped amino functions, which are referred to as polyaldimines and polyketimines in the context of the invention, have a molecular weight Mₙ of 112 to 6500 g/mol, preferably 140 to 2500 g/mol and more preferably 140 to 458 g/mol. If the molecular weight cannot readily be determined as the sum of the atomic weights of the individual elements, it can, for example, be calculated from the functionality and the content of functional groups (established e.g. by determining the primary amino groups present after hydrolysis) or, in the case of higher molecular weight compounds, it can be determined by gel permeation chromatography using polystyrene as the standard.

The preferred polyaldimines and polyketimines include compounds corresponding to formula III) 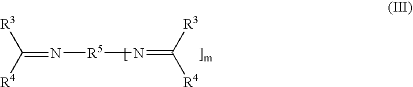
wherein
R³ and R⁴ are the same or different and represent hydrogen or a hydrocarbon group with up to 20 carbon atoms, or R³ and R⁴ form a 5- or 6-membered cycloaliphatic ring together with the carbon atom,
R⁵ is an (m+1)-valent residue obtained by removing the primary amino groups from a corresponding polyamine optionally containing oxygen and/or nitrogen atoms, and
m is an integer from 1 to 3.

R³ and R⁴, independently of one another, are preferably alkyl residues with 1 to 8 carbon atoms.

The polyamine from which R⁵ is obtained preferably has a number-average molecular weight Mₙ of 88 to 2000 g/mol.

Compounds of formula III) in which all R³ groups represent hydrogen, all R⁴ groups represent a hydrocarbon residue with up to 8 carbon atoms and m=1 are particularly preferred.

The aldehydes and ketones that can be used for the production of the polyaldimines and polyketimines, respectively, correspond to formula IV) 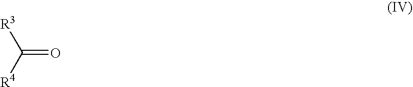
and preferably have a molecular weight of 44 to 128 g/mol (aldehydes) and 58 to 198 g/mol (ketones).

Suitable aldehydes include acetaldehyde, propionaldehyde, n-butyraldehyde, isobutyraldehyde, trimethylacetaldehyde, 2,2-dimethylpropanal, 2-ethylhexanal, 3-cyclohexane-1-carboxaldehyde, hexanal, heptanal, octanal, valeraldehyde, benzaldehyde, tetrahydrobenzaldehyde, hexahydrobenzaldehyde, propargyl-aldehyde, p-toluylaldehyde, phenylethanal, 2-methylpentanal, 3-methylpentanal, 4-methylpentanal and sorbinaldehyde. Preferred are n-butyraldehyde, isobutyraldehyde, trimethylacetaldehyde, 2-ethylhexanal and hexahydrobenzaldehyde.

Suitable ketones include acetone, methyl ethyl ketone, methyl propyl ketone, methyl isopropyl ketone, methyl butyl ketone, methyl isobutyl ketone, methyl tert-butyl ketone, methyl n-amyl ketone, methyl isoamyl ketone, methyl heptyl ketone, methyl undecyl ketone, diethyl ketone, ethyl butyl ketone, ethyl amyl ketone, diisopropyl ketone, diisobutyl ketone, cyclohexanone, cyclopentanone, methylcyclohexanone, isophorone, 5-methyl-3-heptanone, 1-phenyl-2-propanone, acetophenone, methyl nonyl ketone, dinonyl ketone and 3,3,5-trimethylcyclohexanone. Preferred ketones are cyclopentanone, cyclohexanone, methylcyclopentanone, methylcyclohexanone, 3,3,5-trimethylcyclopentanone, cyclobutanone, methylcyclobutanone, acetone, methyl ethyl ketone and methyl isobutyl ketone.

Mixtures of different ketones or aldehydes, as well as mixtures of ketones with aldehydes can also be used to achieve special properties.

The polyamines used in the production of the polyaldimines and polyketimines are organic compounds having at least two, preferably 2 (m=1), aliphatically and/or cycloaliphatically bound primary amino groups. While the use of amines having aromatically bound amino groups is also possible, this is less preferred. The polyamines generally have a number average molecular weight of 60 to 6000 g/mol, preferably 88 to 2000 g/mol and more preferably 88 to 238 g/mol. Suitable polyamines for the production of the polyaldimines and polyketimines include the compounds previously mentioned for preparing polyaspartates B). Different polyamines can be used for the production of polyaspartates B) and the optional polyaldimines and polyketimines, respectively.

The production of the polyaldimines and polyketimines takes place in known manner by reacting the starting components while maintaining a stoichiometric ratio of amino groups to aldehyde or keto groups of 1:1 to 1:1.5. To accelerate the reaction, catalytic quantities of acidic substances, such as e.g. p-toluenesulfonic acid, hydrogen chloride, sulfuric acid or aluminium chloride, can optionally be incorporated.

The reaction generally takes place within the temperature range of 20 to 180° C., and is optionally carried out using an entrainer (e.g. toluene, xylene, cyclohexane and octane) to remove the water of reaction until the calculated quantity of water (1 mole of water per mole of primary amino group) has been eliminated or until no more water is eliminated. The phases are then separated or the entrainer and any unreacted educts present are removed by distillation.

The products thus obtained can be used together with component B) without any further purification.

When polyaldimines and/or polyketimines are incorporated together with the aspartates, the weight ratio of aspartates B) to the optional polyaldimines or polyketimines is 99:1 to 5:95, preferably 80:20 to 20:80.

The ratio of free or blocked amino groups to free NCO groups in the coating compositions according to the invention is preferably 0.5:1 to 1.5:1, more preferably 1:1 to 1.5:1.

To produce the two-component binders according to the invention, the individual components are mixed together.

The coating compositions can be applied on to surfaces using known techniques, such as spraying, dipping, flow coating, rolling, brushing or pouring. After allowing any solvents present to evaporate, the coatings then harden under ambient conditions or at higher temperatures of, e.g., 40 to 200° C.

The coating compositions can be applied, e.g., on to metals, plastics, ceramics, glass and natural materials, and to substrates that have been subjected to any pre-treatment that may be necessary.

### EXAMPLES

Unless otherwise specified, all percentages are to be understood as percentages by weight.

The dynamic viscosities were determined at 23° C. with a rotational viscometer (ViscoTester® 550, Thermo Haake GmbH, D-76227 Karlsruhe).

The flow time was determined in accordance with DIN 53211 as a measure of the pot life.

The Hazen color value was determined in accordance with DIN EN 1557.

The drying rate was determined in accordance with DIN 53150, DIN EN ISO 1517.

The König pendulum hardness was determined in accordance with DIN 53157 (after drying for 10 min at 60° C. and then storing for 7 days at room temperature).

Educts:

SN: Solvent naphtha (Solvesso 100, Exxon Mobil, USA); high-boiling hydrocarbon mixture with a flash point of 55 to 100° C.

BA: butyl acetate

Baysilone OL 17: flow additive based on a polyether-modified polysiloxane, Borchers GmbH, Langenfeld, DE

Tinuvin 292: light stabilizer, HALS, based on a sterically hindered amine, Ciba Specialty Chemicals, Basel, CH

Tinuvin 384-2: light stabilizer, UV absorber, based on benzotriazole, Ciba Specialty Chemicals, Basel, CH

Polyisocyanate A1-I: Desmodur® XP 2570, sulfonate group-containing aliphatic polyisocyanate prepared from HDI with an NCO content of 20.6% and a viscosity at 23° C. of 3500 mPas, Bayer MaterialScience AG, Leverkusen, DE

Polyisocyanate A1-II: Desmodur® XP 2487/1, sulfonate group-containing aliphatic polyisocyanate prepared from HDI with an NCO content of 20.9% and a viscosity at 23° C. of 6900 mPas, Bayer MaterialScience AG, Leverkusen, DE

Polyisocyanate A2: Desmodur® XP 2410, asymmetrical HDI trimer with an NCO content of 23.7% and a viscosity at 23° C. of 700 mPas, Bayer MaterialScience AG, Leverkusen, DE

Polyaspartate B1-I: Desmophen NH 1420, obtained by the addition of 1 mole of 4,4′-diaminodicyclohexylmethane and 2 moles of diethyl maleate, equivalent weight: 277 g with a viscosity of 1500 mPa·s

Polyaspartate B1-II: Desmophen VPLS 2973, obtained by the addition of 1 mole of 3,3′-dimethyl-4,4′-diaminodicyclohexylmethane and 2 moles of 90% diethyl maleate in BA, equivalent weight 323 g with a viscosity of 150 mPa·s

Polyaldimine B2: Desmophen VPLS 2142, obtained by the addition of 1 mole of 1-amino-3,3,5-trimethyl-5-aminomethylcyclohexane (IPDA) and 2 moles of isobutyraldehyde, equivalent weight 139 g, viscosity 25 mPa·s

TABLE 1
Coating composition and application data
(quantities given in parts by weight)

| | Example | | | |
|---|---|---|---|---|
| | 1 | 2 | 3 | 4 |
| Component A: | | | | |
| Polyisocyanate A1-I | 39.17 | | 34.56 | |
| Polyisocyanate A1-II | | 38.59 | | 34.29 |
| SN 100:BA 1:9 | | | 11.52 | 11.43 |
| Component B: | | | | |
| Polyaspartic acid A1-I | 26.75 | 26.75 | | |
| Polyaspartic acid A1-II | | | 26.46 | 26.65 |
| Polyaldimine A2 | 13.36 | 13.36 | 13.22 | 13.31 |
| Baysilone OL17 10% in MPA | 0.36 | 0.36 | 0.36 | 0.36 |
| Tinuvin 292 | 1.00 | 1.00 | 1.00 | 1.00 |
| Tinuvin 384-2 | 1.51 | 1.51 | 1.50 | 1.50 |
| SN 100:BA 1:9 | 12.20 | 12.20 | 11.38 | 11.46 |
| Color value Component A | | | | |
| Immediately | 121 | 121 | | |
| 9 weeks RT | 141 | 141 | | |
| Flow time DIN4 (sec) after | | | | |
| 0.0 h | 18 | 17 | 17 | 19 |
| 0.5 | 21 | 23 | 20 | 21 |
| 1.0 | 25 | 30 | 21 | 23 |
| 2.0 | 40 | 50 | 22 | 24 |
| 4.0 | 60 | 95 | 23 | 25 |
| Drying period RT | | | | |
| T1 + min | 15 | 15 | 15 | 30 |
| T3 + min | 30 | 30 | 40 | 45 |
| T4 + min | 40 | 40 | 90 | 100 |
| Pendulum hardness | | | | |
| 1 d RT | 150 | 151 | 51 | 113 |
| 7 d RT | 160 | 157 | 112 | 129 |

TABLE 2
Coating composition and application data (quantities
given in parts by weight): Comparison

| | Example | | |
|---|---|---|---|
| | 5 | 6 | 7 |
| Component A: | | | |
| Polyisocyanate A2 | 33.58 | | 32.83 |
| Polyisocyanate A1-I | | 38.59 | |
| Polyisocyanate A1-II | | | |
| SN 100:BA 1:9 | 11.23 | | |
| Component B: | | | |
| Polyaspartic acid A1-I | 26.75 | 26.75 | |
| Polyaspartic acid A1-II | | | 29.31 |
| Polyaldimine A2 | 13.36 | 13.36 | 14.64 |
| Baysilone OL17 10% in MPA | 0.36 | 0.36 | 0.37 |
| Tinuvin 292 | 1.00 | 1.00 | 1.00 |
| Tinuvin 384-2 | 1.51 | 1.51 | 1.50 |
| SN 100:BA 1:9 | 12.20 | 12.20 | 9.37 |
| Dodecylbenzoic acid 10% in xylene | | 2.0 | |
| Colour value Component A | | | |
| Immediately | 121 | 143 | |
| 9 weeks RT | 141 | 303 | |
| Flow time DIN4 (sec) after | | | |
| 0.0 h | 16 | 17 | 15 |
| 0.5 | 19 | 23 | 15 |
| 1.0 | 25 | 30 | 16 |
| 2.0 | 47 | 50 | 17 |
| 4.0 | 90 | 95 | 19 |
| Drying period RT | | | |
| T1 + min | 35 | 15 | 70 |
| T3 + min | 60 | 30 | 180 |
| T4 + min | 90 | 40 | 210 |
| Pendulum hardness | | | |
| 1 d RT | 154 | 151 | 155 |
| 7 d RT | 155 | 157 | 168 |

Examples 1 and 2 displayed rapid drying with a long pot life (flow time) in contrast to comparison example 5. While comparison example 6 displayed rapid drying and a long pot life (flow time), component B was subject to marked yellowing.

In contrast to comparison example 7, examples 3 and 4 displayed rapid drying with a long pot life (flow time).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A two-component coating system for the production of polyurea coatings, which comprises
A) a sulfonate group-containing polyisocyanate and
B) an amino-functional polyaspartate corresponding to formula I) 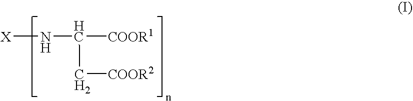
wherein
X represents an n-valent organic group obtained by removing the primary amino groups from an n-valent polyamine,
R¹, R² represent the same or different organic groups, which are inert to isocyanate groups under the reaction conditions, and
n represents an integer of at least 2.

2. The two-component coating system of claim 1 wherein sulfonate-modified polyisocyanate A) is prepared from hexamethylene diisocyanate, isophorone diisocyanate and/or 4,4′-dicyclohexylmethane diisocyanate.

3. The two-component coating system of claim 1 wherein the sulfonate-modified polyisocyanate A) has an average isocyanate functionality of at least 1.8, an isocyanate group content (calculated as NCO, molecular weight 42) of 4.0 to 26.0 wt. %, a content of bound sulfonic acid and sulfonate groups (calculated as SO₃⁻, molecular weight 80) of 0.1 to 7.7 wt. % and 0 to 19.5 wt. % of ethylene oxide units (calculated as C₂H₂O, molecular weight 44) bound within polyether chains.

4. The two-component coating system of claim 3 wherein sulfonate-modified polyisocyanate A) is prepared from hexamethylene diisocyanate, isophorone diisocyanate and/or 4,4′-dicyclohexylmethane diisocyanate.

5. The two-component coating system of claim 1 wherein component A) also contains a sulfonate group-free polyisocyanate a weight ratio of sulfonate group-containing polyisocyanate to sulfonate group-free polyisocyanate of 80:20 to 20:80.

6. The two-component coating system of claim 1 wherein said n-valent polyamine comprises 1,4-diaminobutane, 1,6-diaminohexane, 2,2,4- and/or 2,4,4-trimethyl-1,6-diaminohexane, 1-amino-3,3,5-trimethyl-5-aminomethylcyclo-hexane, 4,4′-diaminodicyclohexylmethane or 3,3′-dimethyl-4,4′-diaminodicyclo-hexylmethane.

7. The two-component coating system of claim 2 wherein said n-valent polyamine comprises 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, 4,4′-diaminodicyclohexylmethane or 3,3′-dimethyl-4,4′-diaminodicyclo-hexylmethane.

8. The two-component coating system of claim 3 wherein said n-valent polyamine comprises 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, 4,4′-diaminodicyclohexylmethane or 3,3′-dimethyl-4,4′-diaminodicyclo-hexylmethane.

9. The two-component coating system of claim 4 wherein said n-valent polyamine comprises 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, 4,4′-diaminodicyclohexylmethane or 3,3′-dimethyl-4,4′-diaminodicyclo-hexylmethane.

10. The two-component coating system of claim 1 wherein R¹ and R² are the same and represent methyl or ethyl.

11. The two-component coating system of claim 2 wherein R¹ and R² are the same and represent methyl or ethyl.

12. The two-component coating system of claim 3 wherein R¹ and R² are the same and represent methyl or ethyl.

13. The two-component coating system of claim 4 wherein R¹ and R² are the same and represent methyl or ethyl.

14. The two-component coating system of claim 1 wherein said coating system additionally contains a polyaldimine and/or a polyketimine.

15. The two-component coating system of claim 1 wherein said coating system additionally contains a polyaldimine and/or a polyketimine corresponding to formula III) 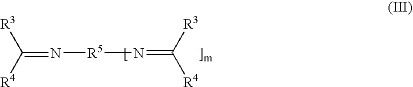
wherein
R³ and R⁴ are the same or different and represent hydrogen or a hydrocarbon residue with up to 20 carbon atoms, or R³ and R⁴ form a 5- or 6-membered cycloaliphatic ring together with the carbon atom,
R⁵ is an (m+1)-valent residue, as obtained by removal of the primary amino groups from a corresponding polyamine optionally containing oxygen and/or nitrogen atoms,
m is an integer from 1 to 3.

16. The two-component coating system of claim 4 wherein said coating system additionally contains a polyaldimine and/or a polyketimine corresponding to formula III) 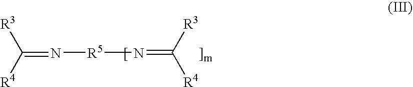
wherein
R³ and R⁴ are the same or different and represent hydrogen or a hydrocarbon residue with up to 20 carbon atoms, or R³ and R⁴ form a 5- or 6-membered cycloaliphatic ring together with the carbon atom,
R⁵ is an (m+1)-valent residue, as obtained by removal of the primary amino groups from a corresponding polyamine optionally containing oxygen and/or nitrogen atoms,
m is an integer from 1 to 3.

17. The two-component coating system of claim 9 wherein said coating system additionally contains a polyaldimine and/or a polyketimine corresponding to formula III) 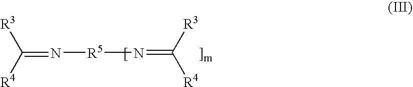
wherein
R³ and R⁴ are the same or different and represent hydrogen or a hydrocarbon residue with up to 20 carbon atoms, or R³ and R⁴ form a 5- or 6-membered cycloaliphatic ring together with the carbon atom,
R⁵ is an (m+1)-valent residue, as obtained by removal of the primary amino groups from a corresponding polyamine optionally containing oxygen and/or nitrogen atoms,
m is an integer from 1 to 3.

18. The two-component coating system of claim 15 wherein the ratio of polyaspartate B) to polyaldimine and/or polyketimine is 80:20 to 20:80.

19. The two-component coating system of claim 1 wherein the ratio of free or blocked amino groups to free NCO groups is 1:1 to 1.5:1.

20. A coating obtained from the two-component coating system of claim 1.
